(19) United States
(12) Patent Application Publication
(10) Pub. No.: US 2014/0043986 A1
(43) Pub. Date: Feb. 13, 2014

(54) RADIO COMMUNICATION DEVICES AND METHODS FOR CONTROLLING A RADIO COMMUNICATION DEVICE

(71) Applicants: Johann Steger, Muenchen (DE); Michael Weber, Freising (DE); Gerald Bauer, Zirndorf (DE); Michael Esch, Nuernberg (DE)

(72) Inventors: Johann Steger, Muenchen (DE); Michael Weber, Freising (DE); Gerald Bauer, Zirndorf (DE); Michael Esch, Nuernberg (DE)

(73) Assignee: INTEL MOBILE COMMUNICATIONS GMBH, Neubiberg (DE)

(21) Appl. No.: 13/569,269

(22) Filed: Aug. 8, 2012

(51) Int. Cl. H04W 72/08; H04W 24/00

(52) U.S. Cl. 370/252

(57) ABSTRACT

A radio communication device may be provided, including: a transceiver to exchange data with a base station; a mode determiner to determine whether to operate the radio communication device in a pre-determined mode, in which a first subset of frames of each multiframe in a plurality of multiframes is reserved for a first group of radio communication devices including the radio communication device for sending data to the base station and/or receiving data from the base station, and a second subset of frames of each multiframe in the plurality of multiframes is reserved for a second group of other radio communication devices for sending data to the base station and/or receiving data from the base station; and a measurement circuit to measure a reception quality of a pre-determined cell in the second subset if the mode determiner determines to operate the radio communication device in the pre-determined mode.

### TECHNICAL FIELD

Aspects of this disclosure relate generally to radio communication devices and methods for controlling a radio communication device.

### BACKGROUND

Radio communication devices may communicate with a radio base station. The radio base station may assign radio resources to the radio communication device for exchanging data between the radio communication device and the base station. In case the radio communication device is moving fast through the coverage of a plurality of radio base stations, it may be difficult for the radio communication device to perform measurements sufficiently fast for keeping the information about the coverage of the different radio base stations updated.

### SUMMARY

A radio communication device may be provided. The radio communication device may include: a transceiver configured to exchange data with a base station in accordance with a plurality of multiframe structures, each having a plurality of multiframes, and wherein each multiframe may include a plurality of frames; a mode determiner configured to determine whether to operate the radio communication device in a pre-determined mode, in which a first subset of frames of each multiframe in the plurality of multiframes is reserved by the base station for a first group of radio communication devices including the radio communication device for at least one of sending data to the base station and receiving data from the base station, and a second subset of frames of each multiframe in the plurality of multiframes is reserved by the base station for a second group of radio communication devices for at least one of sending data to the base station and receiving data from the base station; and a measurement circuit configured to measure a reception quality of a pre-determined cell in the second subset, if the mode determiner determines to operate the radio communication device in the pre-determined mode.

A method for controlling a radio communication device may be provided. The method may include: exchanging data with a base station in accordance with a plurality of multiframe structures, each multiframe structure having a plurality of multiframes, and wherein each multiframe includes a plurality of frames; determining whether to operate the radio communication device in a pre-determined mode, in which a first subset of frames of each multiframe in the plurality of multiframes is reserved by the base station for a first group of radio communication devices including the radio communication device for at least one of sending data to the base station and receiving data from the base station, and a second subset of frames of each multiframe in the plurality of multiframes is reserved by the base station for a second group of radio communication devices for at least one of sending data to the base station and receiving data from the base station; and measuring a reception quality of a pre-determined cell in the second subset if the radio communication device is determined to be operated in the pre-determined mode.

A radio communication device may be provided. The radio communication device may include: a transceiver configured to exchange data with a base station in accordance with a plurality of multiframe structures, each having a plurality of multiframes, and wherein each multiframe includes a plurality of frames; wherein the transceiver may further be configured to send or receive data in a first subset of frames of each multiframe in the plurality of multiframes reserved by the base station for a first group of radio communication devices including the radio communication device for at least one of sending data to the base station and receiving data from the base station. The radio communication device may further include a measurement circuit configured to measure a reception quality of a pre-determined cell in a second subset of frames of each multiframe in the plurality of multiframes reserved by the base station for a second group of radio communication devices for at least one of sending data to the base station and receiving data from the base station.

A method for controlling a radio communication device may be provided. The method may include: exchanging data with a base station in accordance with a plurality of multiframe structures, each multiframe structure having a plurality of multiframes, and wherein each multiframe includes a plurality of frames; sending or receiving data in a first subset of frames of each multiframe in the plurality of multiframes reserved by the base station for a first group of radio communication devices including the radio communication device for at least one of sending data to the base station and receiving data from the base station; and measuring a reception quality of a pre-determined cell in a second subset of frames of each multiframe in the plurality of multiframes reserved by the base station for a second group of radio communication devices for at least one of sending data to the base station and receiving data from the base station.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of this disclosure. In the following description, various aspects of this disclosure are described with reference to the following drawings, in which:

FIG. 1 shows a radio communication system;

FIG. 2 shows a radio communication device including a transceiver, a mode determiner, and a measurement circuit;

FIG. 3 shows a radio communication device further including a processor;

FIG. 4 shows a flow diagram illustrating a method for controlling a radio communication device (for example like shown in FIG. 2 or FIG. 3);

FIG. 5 shows a radio communication device including a transceiver and a measurement circuit;

FIG. 6 shows a flow diagram illustrating a method for controlling a radio communication device (for example like shown in FIG. 5);

FIG. 7 shows a diagram illustrating a multiframe structure according to a fullrate mode;

FIG. 8 shows a diagram illustrating a multiframe structure according to a halfrate mode; and

FIG. 9 shows a diagram illustrating a multiframe structure according to a halfrate mode and for performing measurements in transmission breaks.

### DESCRIPTION

The following detailed description refers to the accompanying drawings that show, by way of illustration, specific details and aspects of the disclosure in which the invention may be practiced. These aspects of the disclosure are described in sufficient detail to enable those skilled in the art to practice the invention. Other aspects of the disclosure may be utilized and structural, logical, and electrical changes may be made without departing from the scope of the invention. The various aspects of the disclosure are not necessarily mutually exclusive, as some aspects of the disclosure may be combined with one or more other aspects of the disclosure to form new aspects of the disclosure.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any aspect of this disclosure or design described herein as “exemplary” is not necessarily to be construed as preferred or advantageous over other aspect of this disclosure or designs.

The term “protocol” is intended to include any piece of software, that is provided to implement part of any layer of the communication definition.

As used herein, a radio communication device may be an end-user mobile device (MD). A radio communication device may be any kind of mobile radio communication device, mobile telephone, personal digital assistant, mobile computer, or any other mobile device configured for communication with a mobile communication base station (BS) or an access point (AP) and may be also referred to as a User Equipment (UE), a mobile station (MS) or an advanced mobile station (advanced MS, AMS), for example in accordance with IEEE 802.16m.

The radio communication device may include a memory which may for example be used in the processing carried out by the radio communication device. A memory may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, for example, a floating gate memory, a charge trapping memory, an MRAM (Magnetoresistive Random Access Memory) or a PCRAM (Phase Change Random Access Memory).

A “circuit” may be understood as any kind of a logic implementing entity, which may be special purpose circuitry or a processor executing software stored in a memory, firmware, or any combination thereof. Thus, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”.

Various aspects of this disclosure are provided for devices, and various aspects of this disclosure are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein.

Radio communication devices may communicate with a radio base station. The radio base station may assign radio resources to the radio communication device for exchanging data between the radio communication device and the base station.

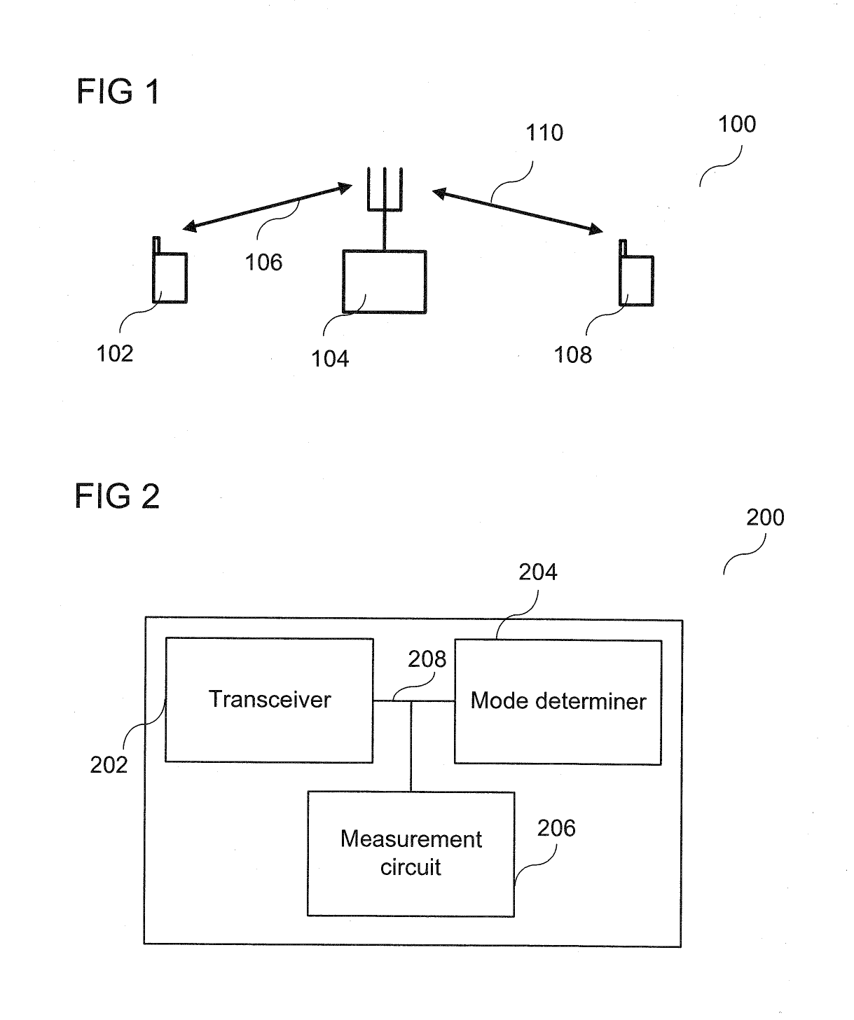

FIG. 1 shows a radio communication system 100. A first radio communication device 102 may communicate with (in other words: perform at least one of sending data to or receiving data from) a base station 104, like indicated by a first arrow 106. A second radio communication device 108 may communicate with (in other words: perform at least one of sending data to or receiving data from) the base station 104, like indicated by a second arrow 110. The first radio communication device 102 and the second radio communication device 108 may share a multiframe, like will be described in more detail below, for communication, and may for example in a time division multiple access scheme communicate with the base station 104 in a round-robin fashion.

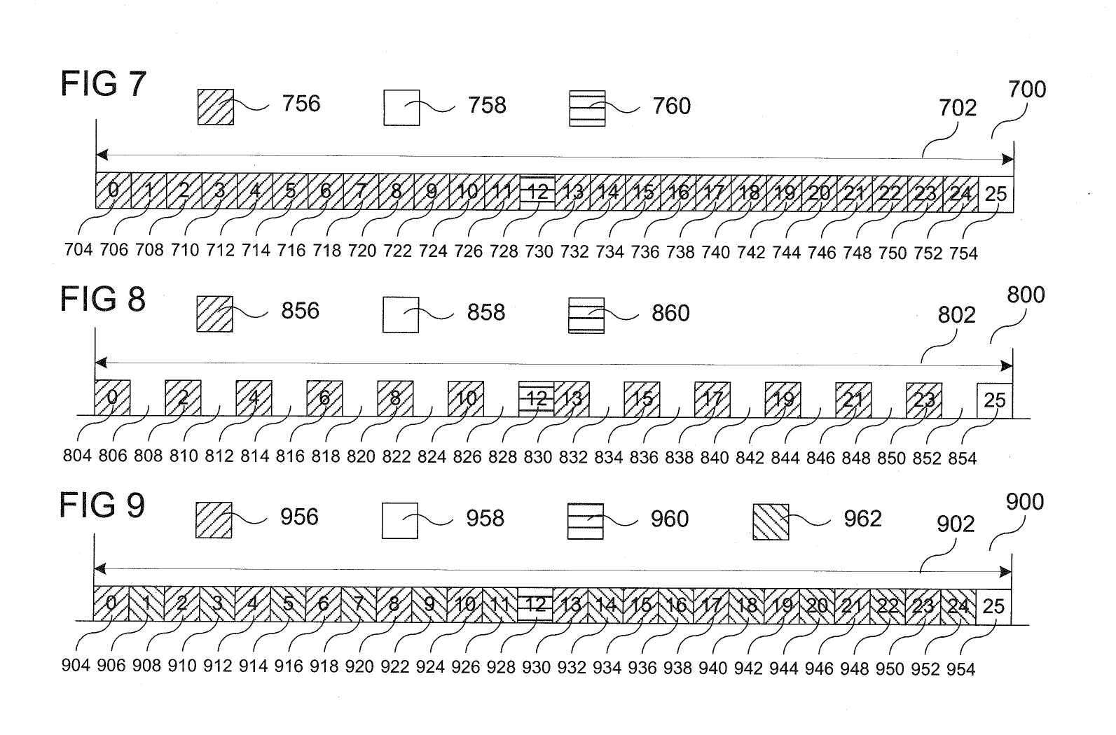

FIG. 7 shows a diagram 700 illustrating a multiframe structure. For example, a GSM fullrate mode may be shown in diagram 700. A multiframe 702, which may for example include 26 frames, for example 26 TDMA frames, may have a length of 120 ms. In each multiframe, traffic frames (indicated by frames filled with lines from lower left to upper right in FIG. 7, according to a first hatching 756) may be provided. A traffic frame may be a frame reserved by the base station for a group of radio communication devices including the radio communication device applying the communication according to the multiframe structure for at least one of sending data to the base station and receiving data from the base station. Furthermore, in each multiframe, one (or exactly one) IDLE frame may be provided, like indicated by a non-filled frame (according to a second hatching 758) in FIG. 7. Furthermore, a SACCH (Slow Associated Control Channel) frame may be provided in each multiframe, like indicated by a frame filled with horizontal lines (according to a third hatching 760). The SACCH may be used to report measurement results to the base station. The idle frame and the SACCH frame may be exchanged, for example the thirteenth frame 728 may be an idle frame and the twenty-sixth frame 754 may be an SACCH frame. In GSM fullrate mode, each multiframe 702 may include the following frames: A first frame 704 as a traffic frame (denoted by number 0); a second frame 706 as a traffic frame (denoted by number 1); a third frame 708 as a traffic frame (denoted by number 2); a fourth frame 710 as a traffic frame (denoted by number 3); a fifth frame 712 as a traffic frame (denoted by number 4); a sixth frame 714 as a traffic frame (denoted by number 5); a seventh frame 716 as a traffic frame (denoted by number 6); an eighth frame 718 as a traffic frame (denoted by number 7); a ninth frame 720 as a traffic frame (denoted by number 8); a tenth frame 722 as a traffic frame (denoted by number 9); an eleventh frame 724 as a traffic frame (denoted by number 10); a twelfth frame 726 as a traffic frame (denoted by number 11); a thirteenth frame 728 as a SACCH frame (denoted by number 12); a fourteenth frame 730 as a traffic frame (denoted by number 13); a fifteenth frame 732 as a traffic frame (denoted by number 14); a sixteenth frame 734 as a traffic frame (denoted by number 15); a seventeenth frame 736 as a traffic frame (denoted by number 16); an eighteenth frame 738 as a traffic frame (denoted by number 17); a nineteenth frame 740 as a traffic frame (denoted by number 18); a twentieth frame 742 as a traffic frame (denoted by number 19); a twenty-first frame 744 as a traffic frame (denoted by number 20); a twenty-second frame 746 as a traffic frame (denoted by number 21); a twenty-third frame 748 as a traffic frame (denoted by number 22); a twenty-fourth frame 750 as a traffic frame (denoted by number 23); and a twenty-fifth frame 752 as a traffic frame (denoted by number 24); and a twenty-sixth frame 754 as an idle frame (denoted by number 25), which according to the GSM standard may be reserved by the base station for the group of radio communication devices for neighbor cell monitoring, so that the radio communication device may perform neighbor cell monitoring in this frame.

FIG. 8 shows a diagram 800 illustrating a multiframe structure. For example, a GSM halfrate mode may be shown in diagram 800. A multiframe 802 may have a length of 120 ms. In each multiframe, traffic frames (indicated by frames filled with lines from lower left to upper right in FIG. 8, according to a first hatching 856) may be provided. A traffic frame may be a frame reserved by the base station for a group of radio communication devices including the radio communication device applying the communication according to the multiframe structure for at least one of sending data to the base station and receiving data from the base station. Furthermore, in each multiframe, one (or exactly one) IDLE frame may be provided, like indicated by a non-filled frame (according to a second hatching 858) in FIG. 8. Furthermore, a SACCH (Slow Associated Control Channel) frame may be provided in each multiframe, like indicated by a frame filled with horizontal lines (according to a third hatching 860). The SACCH may be used to report measurement results to the base station. The idle frame and the SACCH frame may be exchanged, for example the thirteenth frame 828 may be an idle frame and the twenty-sixth frame 854 may be an SACCH frame. Furthermore, in GSM halfrate, there may be provided breaks (denoted by empty areas in FIG. 8) between the frames described above, in which the radio communication device applying the communication according to the multiframe structure may not use for exchanging data with the base station. These breaks may include frames which are reserved by the base station for another group of radio communication devices (which does not include the radio communication device) for at least one of sending data to the base station or receiving data from the base station. In GSM halfrate mode, each multiframe 802 may include the following: A first frame 804 as a traffic frame (denoted by number 0); a second frame 806 as a break (denoted by an empty area); a third frame 808 as a traffic frame (denoted by number 2); a fourth frame 810 as a break (denoted by an empty area); a fifth frame 812 as a traffic frame (denoted by number 4); a sixth frame 814 as a break (denoted by an empty area); a seventh frame 816 as a traffic frame (denoted by number 6); an eighth frame 818 as a break (denoted by an empty area); a ninth frame 820 as a traffic frame (denoted by number 8); a tenth frame 822 as a break (denoted by an empty area); an eleventh frame 824 as a traffic frame (denoted by number 10); a twelfth frame 826 as a break (denoted by an empty area); a thirteenth frame 828 as a SACCH frame (denoted by number 12); a fourteenth frame 830 as a traffic frame (denoted by number 13); a fifteenth frame 832 as a break (denoted by an empty area); a sixteenth frame 834 as a traffic frame (denoted by number 15); a seventeenth frame 836 as a break (denoted by an empty area); an eighteenth frame 838 as a traffic frame (denoted by number 17); a nineteenth frame 840 as a break (denoted by an empty area); a twentieth frame 842 as a traffic frame (denoted by number 19); a twenty-first frame 844 as a break (denoted by an empty area); a twenty-second frame 846 as a traffic frame (denoted by number 21); a twenty-third frame 848 as a break (denoted by an empty area); a twenty-fourth frame 850 as a traffic frame (denoted by number 23); a twenty-fifth frame 852 as a break (denoted by an empty area); and a twenty-sixth frame 854 as an idle frame (denoted by number 25), which according to the GSM standard may be reserved by the base station for the group of radio communication devices for neighbor cell monitoring, so that the radio communication device may perform neighbor cell monitoring in this frame.

When a mobile phone (which may also be referred to as a mobile station (MS) or a radio communication device) is in a speech call, it may desire to continuously monitor all its neighbor cell frequencies (for example as provided by the BA (BCCH (broadcast control channel) Allocation List) list) and report the Rx (receive) signal strengths and BSICs (wherein BSIC may be a base station identity code) of detected neighbor cells back to the base station. The base station may take this information to be prepared for a handover in case the radio link to the MS is getting worse and worse. In that case, the base station may introduce a handover to a cell that can be better received by the MS.

A challenge for this procedure may arise when the radio link behavior changes very quickly, which may mean that the receive quality or receive strength of the current cell may drop rapidly while new neighboring cells come up, for example with the same speed. In this case, it may be very important that upcoming neighbor cells are found very quickly and the results may be reported back to the base station (and thus to the network). Otherwise, the current link may become bad and may finally drop because the network does not have any cells where to hand over. This behavior may especially be seen in very dense networks with small cells and high frequency reuse.

In GSM (Global System for Mobile Communications) systems, a FULLRATE mode (FR) may be provided. In this mode the only chance to do cell search and BSIC detection for neighbor cell monitoring may be an IDLE frame, like described above. This may mean that only one TDMA (time division multiple access) frame out of 26 TDMA frames may be used for neighbor cell searches, BSIC detection and BSIC reconfirmation. This restriction may result in an overall scan time of about 11*26 TDMA frames which may amount to about 1.5 seconds for one particular frequency. If there are several strong frequencies in a cell list, all these other frequencies may be desired to be scanned as well, and it may take a while until one particular frequency is scanned again (for example about 20 to 30 seconds).

In HALFRATE mode, two mobile phones may share one fullrate channel: one MS may get the even numbered TDMA frame numbers while the other MS may get the odd ones (or, like shown in FIG. 8, one MS may get the even numbered TDMA frames in the first half of the multiframe (for example 804, 808, 812, 816, 820, and 824), and the odd numbered TDMA frames in the second half of the multiframe (for example 830, 834, 838, 842, 846, and 850)), and the other MS may get the remaining frames (for example 806, 810, 814, 818, 822, 826, 832, 836, 840, 844, 848, and 852). According to the GSM standard, in HALFRATE mode, commonly only the IDLE frame 754 or 854 (one TDMA frame out of 26 TDMA frames) may be used for neighbor cell searches, BSIC detection and BSIC reconfirmation. This may lead to long neighbor cell search time in HALFRATE, which may take as long as in FULLRATE.

In halfrate mode, every other TDMA frame may be free for each MS (in other words: may provide a break) and may be used for additional neighbor cell measurements. Instead of one TDMA frame out of 26 (as in FULLRATE, for example frame 754 of FIG. 7) up to 13 TDMA frames (for example 906, 910, 914, 918, 922, 926, 932, 936, 940, 944, 948, 952, and 954, like will be described below for FIG. 9) out of 26 may be used for cell searches, BSIC detection and BSIC reconfirmation on neighbor cell frequencies. This may speed up the overall search time for neighbor cells significantly.

FIG. 9 shows a diagram 900 illustrating a multiframe structure. A multiframe 902 may have a length of 120 ms. In each multiframe, traffic frames (indicated by frames filled with lines from lower left to upper right in FIG. 9, according to a first hatching 956) may be provided. A traffic frame may be a frame reserved by the base station for a group of radio communication devices including the radio communication device applying the communication according to the multiframe structure for at least one of sending data to the base station and receiving data from the base station. Furthermore, in each multiframe, one (or exactly one) IDLE frame may be provided, like indicated by a non-filled frame (according to a second hatching 958) in FIG. 9. Furthermore, a SACCH (Slow Associated Control Channel) frame may be provided in each multiframe, like indicated by a frame filled with horizontal lines (according to a third hatching 960). The SACCH may be used to report measurement results to the base station. The idle frame and the SACCH frame may be exchanged, for example the thirteenth frame 928 may be an idle frame and the twenty-sixth frame 954 may be an SACCH frame. Furthermore, in GSM halfrate, there may be provided breaks (denoted by frames filled with lines from upper left to lower right in FIG. 9, according to a fourth hatching 962) between the frames described above. These breaks may include frames which are reserved by the base station for another group of radio communication devices (which does not include the radio communication device) for at least one of sending data to the base station or receiving data from the base station. These breaks (or break frames, or frames reserved by the base station for the other group of radio communication devices for at least one of sending data to the base station or receiving data from the base station) may be used by the radio communication device for measuring a reception quality of a pre-determined cell (or in other words: to monitor neighbor cells). The break frames may also be referred to as additional search frames, and it will be understood that measurements may be performed in all (for example in all 12) of the additional search frames or in a subset of the additional search frames. In GSM halfrate mode, each multiframe 902 may include the following: A first frame 904 as a traffic frame (denoted by number 0); a second frame 906 as an additional search frame (denoted by number 1); a third frame 908 as a traffic frame (denoted by number 2); a fourth frame 910 as an additional search frame (denoted by number 3); a fifth frame 912 as a traffic frame (denoted by number 4); a sixth frame 914 as an additional search frame (denoted by number 5); a seventh frame 916 as a traffic frame (denoted by number 6); an eighth frame 918 as an additional search frame (denoted by number 7); a ninth frame 920 as a traffic frame (denoted by number 8); a tenth frame 922 as an additional search frame (denoted by number 9); an eleventh frame 924 as a traffic frame (denoted by number 10); a twelfth frame 926 as an additional search frame (denoted by number 11); a thirteenth frame 928 as a SACCH frame (denoted by number 12); a fourteenth frame 930 as a traffic frame (denoted by number 13); a fifteenth frame 932 as an additional search frame (denoted by number 14); a sixteenth frame 934 as a traffic frame (denoted by number 15); a seventeenth frame 936 as an additional search frame (denoted by number 16); an eighteenth frame 938 as a traffic frame (denoted by number 17); a nineteenth frame 940 as an additional search frame (denoted by number 18); a twentieth frame 942 as a traffic frame (denoted by number 19); a twenty-first frame 944 as an additional search frame (denoted by number 20); a twenty-second frame 946 as a traffic frame (denoted by number 21); a twenty-third frame 948 as an additional search frame (denoted by number 22); a twenty-fourth frame 950 as a traffic frame (denoted by number 23); a twenty-fifth frame 952 as an additional search frame (denoted by number 24); a twenty-sixth frame 954 as an idle frame (denoted by number 25), which according to the GSM standard may be reserved by the base station for the group of radio communication devices for neighbor cell monitoring, so that the radio communication device may perform neighbor cell monitoring also in this frame.

The TDMA frames reserved for the other substream in case of HALFRATE may be used for neighbor cell search, BSIC detection and BSIC reconfirmation in addition to the IDLE frame. Each neighbor cell frequency that may be desired to be scanned may get assigned its own search frame. In an example, like described above, there may be 13 free TDMA frames in the 26 multiframe structure. In this way, several frequencies may be scanned concurrently which may reduce the overall search time. Upcoming neighbor cells may be detected faster, allowing earlier handovers and reducing the risk of call drops in particular in radio environments with high fluctuations in radio signal strength.

In case of HALFRATE mode, the TDMA frames reserved for the other substream may be used for neighbor cell searches, BSIC detection and BSIC reconfirmation on top of the IDLE frame. In this way, the neighbor cell list may be updated much faster

Devices and methods may be provided for reduced neighbor cell search time in GSM halfrate mode.

FIG. 2 shows a radio communication device 200. The radio communication device 200 may include a transceiver 202 (or a transceiver circuit 202) configured to exchange data with a base station (not shown) in accordance with a plurality of multiframe structures, each having a plurality of multiframes, and wherein each multiframe may include a plurality of frames. The radio communication device 200 may further include a mode determiner 204 (or a mode determination circuit 204) configured to determine whether to operate the radio communication device 200 in a pre-determined mode, in which a first subset of frames of each multiframe in the plurality of multiframes is reserved by the base station for a first group of radio communication devices including the radio communication device 200 for at least one of sending data to the base station and receiving data from the base station, and a second subset of frames of each multiframe in the plurality of multiframes is reserved by the base station for a second group of (for example other) radio communication devices for at least one of sending data to the base station and receiving data from the base station. The radio communication device 200 may further include a measurement circuit 206 configured to measure a reception quality of a pre-determined cell in the second subset if the mode determiner 204 determines to operate the radio communication device 200 in the pre-determined mode. The transceiver 202, the mode determiner 204, and the measurement circuit 206 may be coupled with each other, e.g. via a connection 208, for example an optical connection or an electrical connection, such as e.g. a cable or a computer bus or via any other suitable electrical connection to exchange electrical signals. As stated above, the first group of radio communication devices may include the radio communication device. As stated above, the second group of radio communication devices may include other radio communication devices (in other words: may not include the radio communication device; in other words: may be free of the radio communication device).

The multiframe structure may include multiframes, wherein each multiframe may be provided according to a pre-determined scheme. For example, all multiframes may have the same structure. For example, each frame denoted by a pre-determined number in a multiframe (for example counted starting from 0) may have the same purpose in any multiframe. For example, each n-th frame in a multiframe may have a pre-determined purpose (wherein n may be an integer between 0 and the number of frames in the multiframe minus 1, or n may be an integer between 1 and the number of frames in the multiframe), like described in more details above.

The transceiver 202 may further be configured to not exchange data with the base station in the second subset. The measurement circuit 206 may further be configured to not measure like in the second subset in the first subset.

The plurality of frames may be according to least one of the following channel access methods: time division multiple access (TDMA); frequency division multiple access (FDMA); code division multiple access (CDMA); spread spectrum multiple access (SSMA); and space-division multiple access (SDMA).

The mode determiner 204 may further be configured to determine whether to operate the radio communication device 200 in the pre-determined mode based on information received from the base station.

The mode determiner 204 may further be configured to determine whether to operate the radio communication device 200 in a further mode, in which all of the plurality of frames except one frame of each multiframe are reserved by the base station for the first group of radio communication devices for at least one of sending data to the base station and receiving data from the base station.

The pre-determined mode may be a Global System for Mobile Communications (GSM) halfrate mode.

The further mode may be a Global System for Mobile Communications (GSM) fullfrate mode.

The measurement circuit 206 may further be configured to measure a reception quality of a pre-determined cell in every frame of the second subset if the mode determiner 204 determines to operate the radio communication device in the pre-determined mode.

The pre-determined cell may be a cell indicated by the base station.

The pre-determined cell may be a cell indicated by a neighboring cell list.

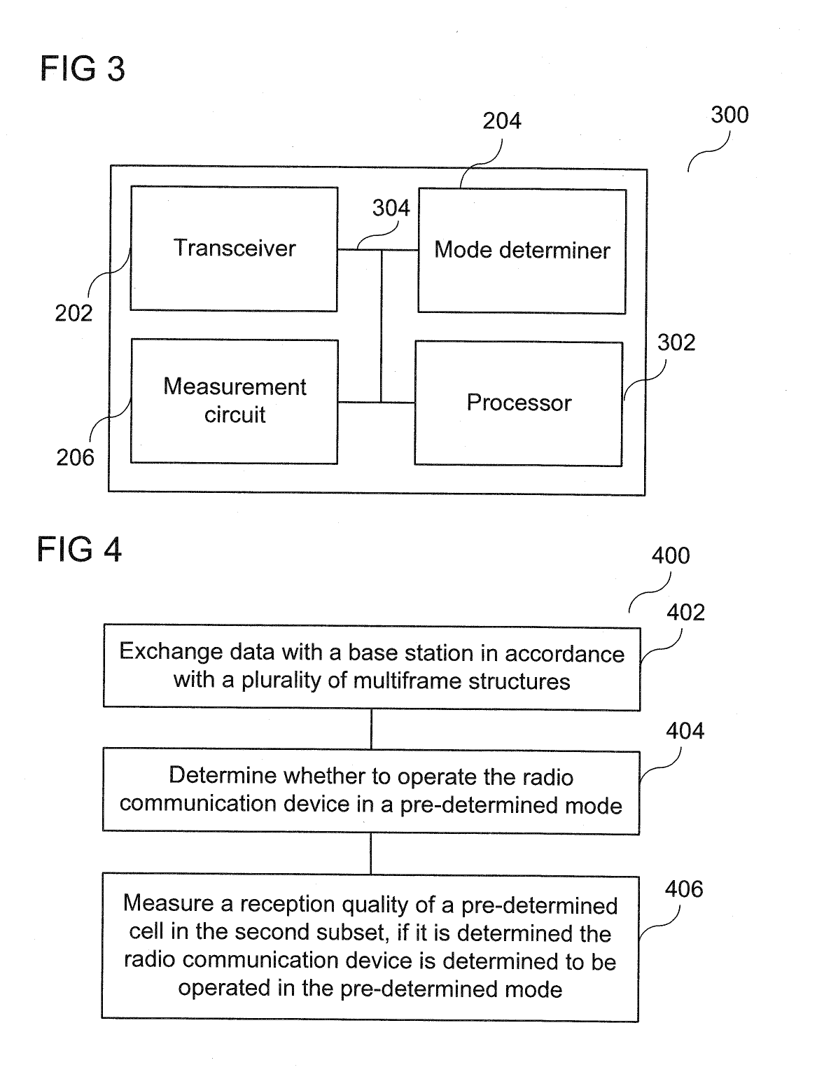

FIG. 3 shows a radio communication device 300. The radio communication device 300 may, similar to the radio communication device 200 of FIG. 2, include a transceiver 202 (or a transceiver circuit 202) configured to exchange data with a base station (not shown) in accordance with a plurality of multiframe structures, each having a plurality of multiframes, and wherein each multiframe may include a plurality of frames. The radio communication device 300 may, similar to the radio communication device 200 of FIG. 2, further include a mode determiner 204 (or a mode determination circuit 204) configured to determine whether to operate the radio communication device 300 in a pre-determined mode, in which a first subset of frames of each multiframe in the plurality of multiframes is reserved by the base station for a first group of radio communication devices including the radio communication device 300 for at least one of sending data to the base station and receiving data from the base station, and a second subset of frames of each multiframe in the plurality of multiframes is reserved by the base station for a second group of (for example other) radio communication devices for at least one of sending data to the base station and receiving data from the base station. The radio communication device 300 may, similar to the radio communication device 200 of FIG. 2, further include a measurement circuit 206 configured to measure a reception quality of a pre-determined cell in the second subset if the mode determiner 204 determines to operate the radio communication device in the pre-determined mode. The radio communication device 300 may further include a processor 302 configured to control the transceiver 202 according to the mode determined by the mode determiner 204. The transceiver 202, the mode determiner 204, the measurement circuit 206, and the processor 302 may be coupled with each other, e.g. via a connection 304, for example an optical connection or an electrical connection, such as e.g. a cable or a computer bus or via any other suitable electrical connection to exchange electrical signals.

The first subset and the second subset may be disjoint.

Each multiframe may include one (for example at least one; for example exactly (or only) one) idle frame reserved by the base station for the first group of radio communication devices for measuring of a reception quality of a cell.

Each multiframe may include or may consist of the idle frame, the frames of the first subset, and the frames of the second subset.

The measurement circuit 206 may further be configured to measure a pre-determined cell in a pre-determined frame of the second subset (in other words: there may be an assignment of the frames in the second subset to cells (or frequencies) that are to be measured).

FIG. 4 shows a flow diagram 400 illustrating a method for controlling a radio communication device. In 402, data may be exchanged with a base station in accordance with a plurality of multiframe structures. Each multiframe structure may have a plurality of multiframes. Each multiframe may include or may be a plurality of frames. In 404, it may be determined whether to operate the radio communication device in a pre-determined mode, in which a first subset of frames of each multiframe in the plurality of multiframes is reserved by the base station for a first group of radio communication devices including the radio communication device for at least one of sending data to the base station and receiving data from the base station, and a second subset of frames of each multiframe in the plurality of multiframes is reserved by the base station for a second group of (for example other) radio communication devices for at least one of sending data to the base station and receiving data from the base station. In 406, a reception quality of a pre-determined cell may be measured in the second subset if the radio communication device is determined to be operated in the pre-determined mode. As stated above, the first group of radio communication devices may include the radio communication device. As stated above, the second group of radio communication devices may include other radio communication devices (in other words: may not include the radio communication device; in other words: may be free of the radio communication device).

A transceiver of the radio communication device may pause exchanging data with the base station in the second subset. The transceiver may not perform measurements like in the second subset in the first subset.

The plurality of frames may be according to least one of the following channel access methods: time division multiple access (TDMA); frequency division multiple access (FDMA); code division multiple access (CDMA); spread spectrum multiple access (SSMA); and space-division multiple access (SDMA).

A mode determiner of the radio communication device may determine whether to operate the radio communication device in the pre-determined mode based on information received from the base station.

The mode determiner may further determine whether to operate the radio communication device in a further mode, in which all of the plurality of frames except one frame of each multiframe are reserved by the base station for the first group of radio communication devices for at least one of sending data to the base station and receiving data from the base station.

The pre-determined mode may be a Global System for Mobile Communications (GSM) halfrate mode.

The further mode may be a Global System for Mobile Communications (GSM) fullfrate mode.

A measurement circuit of the radio communication device may measure a reception quality of a pre-determined cell in every frame of the second subset if the mode determiner determines to operate the radio communication device in the pre-determined mode.

The pre-determined cell may be a cell indicated by the base station.

The pre-determined cell may be a cell indicated by a neighboring cell list.

The method may further include controlling the radio communication device according to the determined mode.

The first subset and the second subset may be disjoint.

Each multiframe may include one (for example at least one, for example exactly (or only) one) idle frame reserved by the base station for the first group of radio communication devices for measuring of a reception quality of a cell.

Each multiframe may include or may consist of the idle frame, the frames of the first subset, and the frames of the second subset.

The measurement circuit may measure a pre-determined cell in a pre-determined frame of the second subset (in other words: there may be an assignment of the frames in the second subset to cells (or frequencies) that are to be measured).

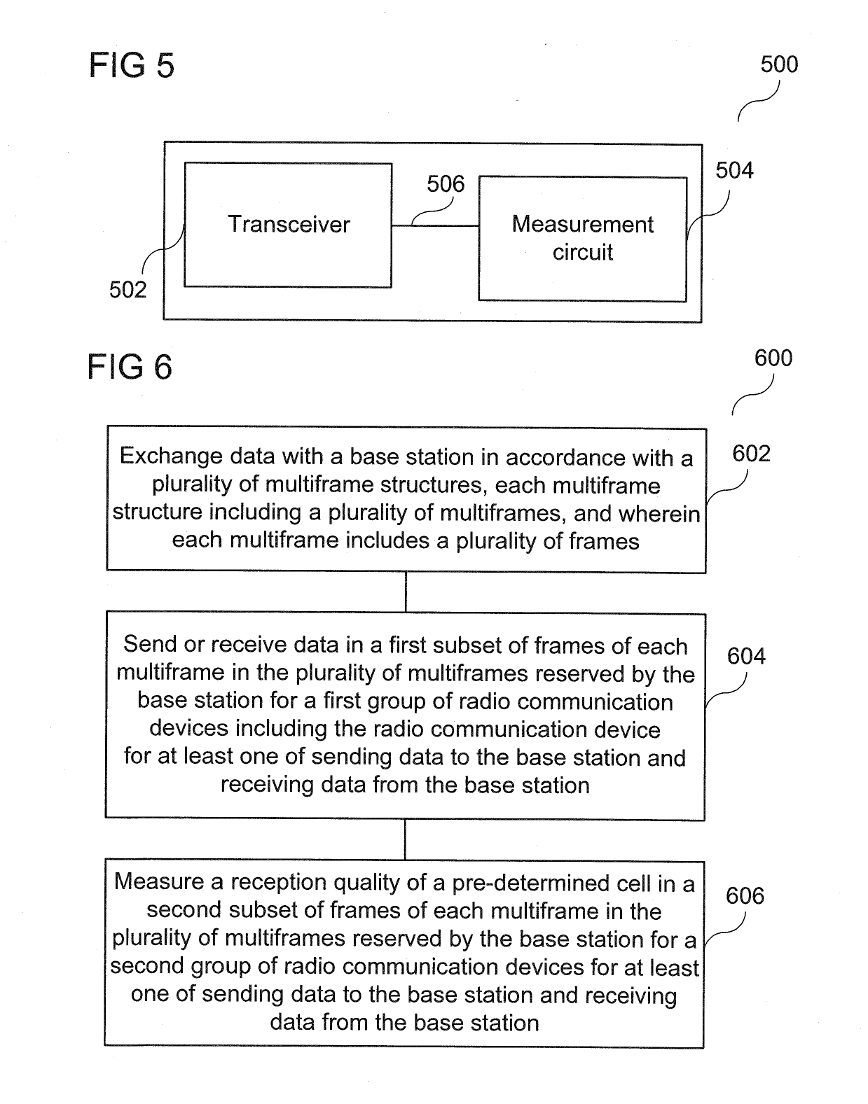

FIG. 5 shows a radio communication device 500. The radio communication device 500 may include a transceiver 502 configured to exchange data with a base station (not shown) in accordance with a plurality of multiframe structures, each multiframe structure having a plurality of multiframes, and wherein each multiframe may include or may be a plurality of frames. The transceiver 502 may be configured to send or receive data in a first subset of frames of each multiframe in the plurality of multiframes reserved by the base station for a first group of radio communication devices including the radio communication device 500 for at least one of sending data to the base station and receiving data from the base station. The radio communication device 500 may further include a measurement circuit 504 configured to measure a reception quality of a pre-determined cell in a second subset of frames of each multiframe in the plurality of multiframes reserved by the base station for a second group of (for example other) radio communication devices for at least one of sending data to the base station and receiving data from the base station. The transceiver 502 and the measurement circuit 504 may be coupled with each other, e.g. via a connection 506, for example an optical connection or an electrical connection, such as e.g. a cable or a computer bus or via any other suitable electrical connection to exchange electrical signals. As stated above, the first group of radio communication devices may include the radio communication device. As stated above, the second group of radio communication devices may include other radio communication devices (in other words: may not include the radio communication device; in other words: may be free of the radio communication device).

FIG. 6 shows a flow diagram 600 illustrating a method for controlling a radio communication device. In 602, a transceiver may exchange data with a base station in accordance with a plurality of multiframe structures. Each multiframe structure may have a plurality of multiframes. Each multiframe may include or may be a plurality of frames. In 604, the transceiver may send or may receive data in a first subset of frames of each multiframe in the plurality of multiframes reserved by the base station for a first group of radio communication devices including the radio communication device for at least one of sending data to the base station and receiving data from the base station. In 606, a measurement circuit may measure a reception quality of a pre-determined cell in a second subset of frames of each multiframe in the plurality of multiframes reserved by the base station for a second group of (for example other) radio communication devices for at least one of sending data to the base station and receiving data from the base station. As stated above, the first group of radio communication devices may include the radio communication device. As stated above, the second group of radio communication devices may include other radio communication devices (in other words: may not include the radio communication device; in other words: may be free of the radio communication device).

Any one of the radio communication devices described above and the data exchange with a base station may be configured according to at least one of the following radio access technologies: a Bluetooth radio communication technology, an Ultra Wide Band (UWB) radio communication technology, and/or a Wireless Local Area Network radio communication technology (for example according to an IEEE 802.11 (for example IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), Worldwide Interoperability for Microwave Access (WiMax) (for example according to an IEEE 802.16 radio communication standard, for example WiMax fixed or WiMax mobile), WiPro, HiperMAN (High Performance Radio Metropolitan Area Network) and/or IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (for example UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard).

While the invention has been particularly shown and described with reference to specific aspects of this disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A radio communication device comprising:
a transceiver configured to exchange data with a base station in accordance with a plurality of multiframe structures, wherein each having a plurality of multiframes, and wherein each multiframe comprises a plurality of frames;
a mode determiner configured to determine whether to operate the radio communication device in a pre-determined mode, in which a first subset of frames of each multiframe in the plurality of multiframes is reserved by the base station for a first group of radio communication devices including the radio communication device for at least one of sending data to the base station and receiving data from the base station, and a second subset of frames of each multiframe in the plurality of multiframes is reserved by the base station for a second group of radio communication devices for at least one of sending data to the base station and receiving data from the base station; and
a measurement circuit configured to measure a reception quality of a pre-determined cell in the second subset if the mode determiner determines to operate the radio communication device in the pre-determined mode.

2. The radio communication device of claim 1,
wherein the transceiver is configured to not exchange data with the base station in the second subset.

3. The radio communication device of claim 1,
wherein the plurality of frames are according to least one channel access method selected from a list of channel access methods consisting of:
time division multiple access;
frequency division multiple access;
code division multiple access;
spread spectrum multiple access; and
space-division multiple access.

4. The radio communication device of claim 1,
wherein the mode determiner is further configured to determine whether to operate the radio communication device in the pre-determined mode based on information received from the base station.

5. The radio communication device of claim 1,
wherein the mode determiner is further configured to determine to operate the radio communication device in a further mode, in which all of the plurality of frames except one frame of each multiframe are reserved by the base station for the first group of radio communication devices for at least one of sending data to the base station and receiving data from the base station.

6. The radio communication device of claim 1,
wherein the pre-determined mode is a Global System for Mobile Communications halfrate mode.

7. The radio communication device of claim 5,
wherein the further mode is a Global System for Mobile Communications fullfrate mode.

8. The radio communication device of claim 1,
wherein the pre-determined cell is a cell indicated by the base station.

9. The radio communication device of claim 1, further comprising:
a processor configured to control the transceiver according to the mode determined by the mode determiner.

10. The radio communication device of claim 1,
wherein each multiframe comprises one idle frame reserved by the base station for the first group of radio communication devices for measuring of a reception quality of a cell.

11. A method for controlling a radio communication device, the method comprising:
exchanging data with a base station in accordance with a plurality of multiframe structures, each multiframe structure having a plurality of multiframes, and wherein each multiframe comprises a plurality of frames;
determining whether to operate radio communication device in a pre-determined mode, in which a first subset of frames of each multiframe in the plurality of multiframes is reserved by the base station for a first group of radio communication devices including the radio communication device for at least one of sending data to the base station and receiving data from the base station, and a second subset of frames of each multiframe in the plurality of multiframes is reserved by the base station for a second group of radio communication devices for at least one of sending data to the base station and receiving data from the base station; and
measuring a reception quality of a pre-determined cell in the second subset if the radio communication device is determined to be operated in the pre-determined mode.

12. The method of claim 11, further comprising:
pausing exchanging data with the base station in the second subset.

13. The method of claim 11,
wherein the plurality of frames are according to least one channel access method selected from a list of channel access methods consisting of:
time division multiple access;
frequency division multiple access;
code division multiple access;
spread spectrum multiple access; and
space-division multiple access.

14. The method of claim 11,
wherein it is determined whether the radio communication device is to be operated in the pre-determined mode based on information received from the base station.

15. The method of claim 11,
wherein it is further determined whether the radio communication device is to be operated in a further mode, in which all of the plurality of frames except one frame of each multiframe are reserved by the base station for the first group of radio communication devices for at least one of sending data to the base station and receiving data from the base station.

16. The method of claim 11,
wherein the pre-determined mode is a Global System for Mobile Communications halfrate mode.

17. The method of claim 11,
wherein the further mode is a Global System for Mobile Communications fullfrate mode.

18. The method of claim 11,
wherein the pre-determined cell is a cell indicated by the base station.

19. The method of claim 11, further comprising:
controlling the radio communication device according to the determined mode.

20. The method of claim 11,
wherein each multiframe comprises one idle frame reserved by the base station for the first group of radio communication devices for measuring of a reception quality of a cell.

21. The method of claim 20,
wherein each multiframe consists of the idle frame, the frames of the first subset, and the frames of the second subset.

22. A radio communication device comprising:
a transceiver configured to exchange data with a base station in accordance with a plurality of multiframe structures, each multiframe structure having a plurality of multiframes, and wherein each multiframe comprises a plurality of frames;
wherein the transceiver is configured to send or receive data in a first subset of frames of each multiframe in the plurality of multiframes reserved by the base station for a first group of radio communication devices comprising the radio communication device for at least one of sending data to the base station and receiving data from the base station; and
a measurement circuit configured to measure a reception quality of a pre-determined cell in a second subset of frames of each multiframe in the plurality of multiframes reserved by the base station for a second group of radio communication devices for at least one of sending data to the base station and receiving data from the base station.

23. The radio communication device of claim 22,
wherein the transceiver is configured to not exchange data with the base station in the second subset.

24. A method for controlling a radio communication device, the method comprising:
exchanging data with a base station in accordance with a plurality of multiframe structures, each multiframe structure having a plurality of multiframes, and wherein each multiframe comprises a plurality of frames;
sending or receiving data in a first subset of frames of each multiframe in the plurality of multiframes reserved by the base station for a first group of radio communication devices comprising the radio communication device for at least one of sending data to the base station and receiving data from the base station; and
measuring a reception quality of a pre-determined cell in a second subset of frames of each multiframe in the plurality of multiframes reserved by the base station for a second group of radio communication devices for at least one of sending data to the base station and receiving data from the base station.

25. The method of claim 24, further comprising:
pausing exchanging data with the base station in the second subset.
